(19) United States
(12) Patent Application Publication
(10) Pub. No.: US 2007/0097245 A1
(43) Pub. Date: May 3, 2007

(54) Digital camera having a touch pad

(76) Inventors: Amy E. Battles, Windsor, CO (US); Daniel J. Byrne, Fort Collins, CO (US); Shanshan Li, Fort Collins, CO (US); Norman C. Pyle, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/262,585

(22) Filed: Oct. 31, 2005

(51) Int. Cl. H04N 5/222

(52) U.S. Cl. 348/333.01

(57) ABSTRACT

A digital camera is disclosed herein. An embodiment of the digital camera comprises a display, wherein previously captured images are displayable on the display when the camera is in a first mode. Images of scenes that are capturable by the camera are displayable on the display when the camera is in a second mode. A touch pad is located proximate the display. Contact of a stylus on the touch pad causes the display to display different previously captured images when the camera is in the first mode. At least one icon representative of at least one function is displayable on the display when the camera is in the second mode. Contact by a stylus on the touch pad proximate the icon causes the at least one function to activate.

U.S. patent application Ser. No. ______, of Amy E. Battles (attorney docket no. 200506143-1), filed on the same day as this application; U.S. patent application Ser. No. ______, Amy E. Battles (attorney docket no. 200506124-1), filed on the same day as this application; U.S. patent application Ser. No. ______, of Amy E. Battles, Daniel J. Byrne, Li Shanshan, Mark J. Bianchi, and Norman C. Pyle (attorney docket no. 200506123-1) filed on the same day as this application; U.S. patent application Ser. No. ______, of Amy E. Battles, Li Shanshan, and Norman C. Pyle (attorney docket no. 200506158-1) filed on the same day as this application; U.S. patent application Ser. No. ______, of Amy E. Battles (attorney docket no. 200506125-1) filed on the same day as this application, are all hereby incorporated by reference for all that is disclosed therein.

### BACKGROUND

As digital cameras become more complex and include more features, more buttons and the like are required to operate these features. As the digital camera technology improves, digital cameras are being made smaller. The combination of smaller digital cameras and more features results in small digital cameras that require a large number of buttons. Thus, digital cameras have a plurality of buttons and the like located in a small area, which can make the operation of the digital cameras cumbersome.

### BRIEF DESCRIPTION OF THE DRAWINGS

FIG. 1 is a rear perspective view of an embodiment of a digital camera.

FIG. 2 is a rear perspective view of the camera of FIG. 1 in an embodiment of a playback mode.

FIG. 3 is a rear perspective view of the camera of FIG. 1 in an embodiment of a live view mode.

### DETAILED DESCRIPTION

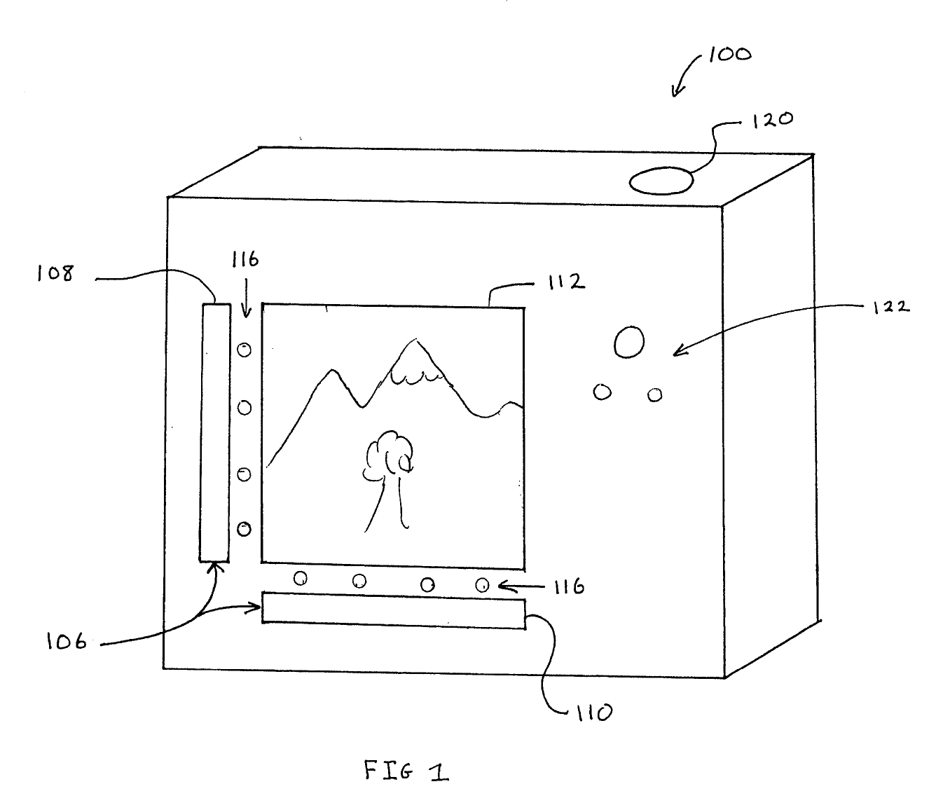

An embodiment of a digital camera 100 is shown in FIG. 1. As described in greater detail below, the digital camera 100 includes touch pads 106 that serve to operate the digital camera 100. The touch pads 106 operate different functions of the camera depending whether the camera is in a review or playback mode or a live view mode. The playback mode is sometimes referred to as the first mode and enables a user to view previously captured images or video clips on a display 112. The live view mode is sometimes referred to as the second mode and enables a user to view scenes or images that may be captured by the digital camera 100. Pressing a button on the digital camera 100 causes the image or scene to be captured.

Having briefly described the digital camera 100, it will now be described in greater detail. The digital camera 100 may include two touch pads 106, which are referred to individually as a first touch pad 108 and a second touch pad 110. As shown in FIG. 1, the touch pads 106 may be substantially rectangular in shape. In some embodiments, the touch pads 106 are able to detect a stylus moving thereon or being pressed thereon. More specifically software associated with the touch pads 106 may be able to detect the sliding or pressing of a stylus. In some embodiments, the software and/or the touch pads 106 are able to distinguish between sliding motion on the touch pads 106 and a stylus being pressed on the touch pads 106. The stylus may be a human finger.

The digital camera 100 may also include a display 112. When the digital camera 100 is in the live view mode, the display 112 may display images or scenes that are focused onto the digital camera 100. These images or scenes may be captured by the digital camera 100 as described in greater detail below. When the digital camera 100 is in the playback mode, previously captured images may be displayed on the display 112. In the embodiment of the digital camera 100 shown in FIG. 1, the first touch pad 108 is located adjacent a vertical edge of the display 112 and the second touch pad 110 is located adjacent a horizontal edge of the display 112. It is noted that the digital camera 100 may have a single touch pad located thereon or more than two touch pads located thereon and that the use of the two touch pads 106 shown in FIG. 1 is for illustration purposes only.

A plurality of LEDs 116 or other lights or indicators may be located on the digital camera 100. In the embodiment of the digital camera 100 shown in FIG. 1, the LEDs 116 are located between the touch pads 106 and the display 112. As described in greater detail below, the LEDs 116 may serve to inform a user of different functions of the digital camera 100 that may be activated by contacting various areas of the touch pads 106.

The digital camera 100 may also include a capture button 120, wherein depressing the capture button 120 causes the digital camera 100 to capture the scene on which it is focused. For example, pressing the capture button 120 will cause an image displayed on the display 112 during live view mode to be captured. The capture button 120 or a similar button may cause the digital camera 100 to capture video. The digital camera 100 may have other buttons 122 located thereon that serve to operate or activate different functions of the digital camera 100.

Having described some of the components of the digital camera 100, the operation of the components and the digital camera 100 will now be described. The digital camera 100 captures images and enables a user to view images or scenes that may be captured via a display 112. The touch pads 106 enable a user to control the functions of the digital camera 100 during the live view mode. Likewise, when the digital camera 100 is in the playback mode, the touch pads 106 enable a user to view different captured images or alter different images. It is noted that the images include video. The LEDs 116 may assist a user in determining how to operate various functions of the digital camera 100 using the touch pads 106.

When the digital camera 100 is in playback mode, the display 112 may display previously captured images that are stored in the digital camera 100 or on some memory device associated with the digital camera 100. The digital camera 100 may be placed in the playback mode by a user pressing one of the buttons 122. The digital camera 100 could also be placed in the playback mode by pressing on one of the touch pads 106 or pressing a location or button on one of the touch pads 106. When the digital camera 100 is in playback mode, changing the image displayed on the display 112 may be achieved by a user sliding a stylus, such as a finger, along the second touch pad 110. The images may be stored in some order, such as chronological order or by name. Sliding the stylus to the right may cause the next image in the order to be displayed. Likewise, sliding the stylus to the left may cause the previous image in the order to be displayed. It is noted that sliding a stylus in a vertical direction on the first touch pad 108 may produce the same viewing results as sliding the stylus in a horizontal direction on the second touch pad 110.

The number of images that change for a predetermined amount of movement of the stylus on the second touch pad 110 may be preselected or set by the user. In some embodiments, each time movement is detected, one different previously captured image is displayed on the display 112. In other embodiments, new previously captured images continue to be displayed on the display as movement is detected. Thus, the images scroll on the display 112 as movement is detected. In the case of stored video, an image representative of the video, such as the first frame of the video may be displayed on the display 112.

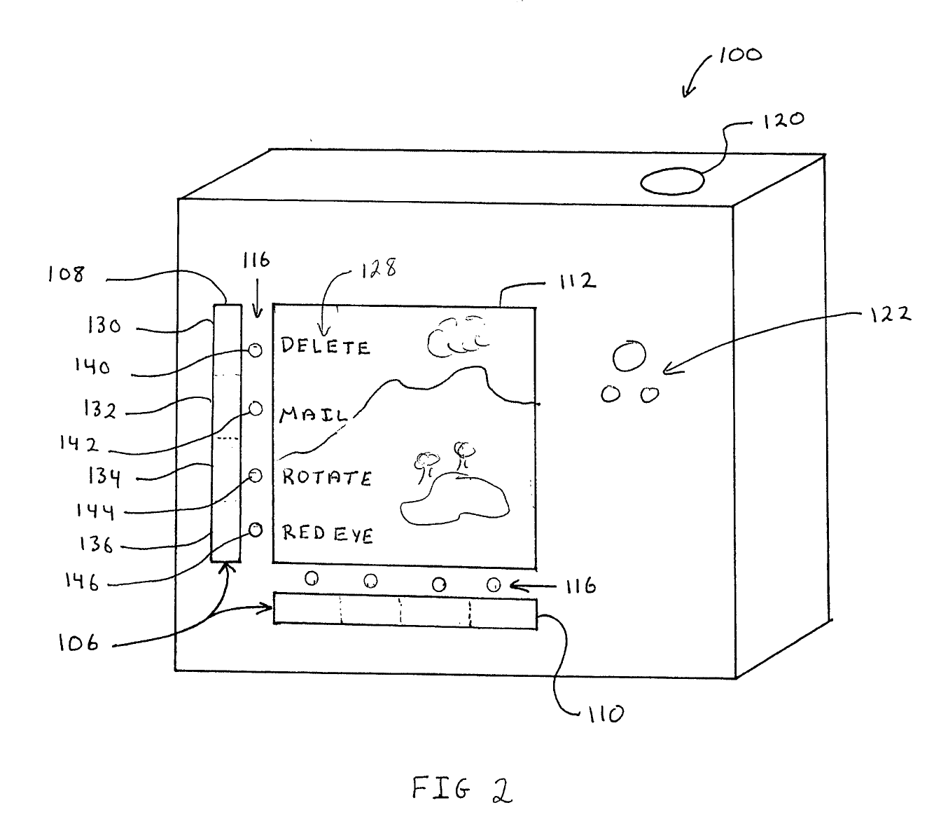

An embodiment of the digital camera 100 in the playback mode is shown in FIG. 2. This embodiment of the playback mode may be obtained by pressing one of the buttons 122 or activating a portion of one of the touch pads 106. For example, sliding a stylus on one of the touch pads 106 may cause the digital camera 100 to enter the playback mode. In this embodiment of the playback mode, the display 112 may display a previously captured image along with actions 128 that may be taken with respect to the displayed image. The actions 128 may appear as light text on the display 112. The actions 128 shown in FIG. 2 are “delete” which may delete the displayed image; “mail” which may cause the displayed image to be sent via electronic mail; “rotate” which may cause the displayed image to rotate; and “red eye” which may remove red eyes. It is noted that the actions shown in FIG. 2 are examples of actions or options and that other actions or options may be available.

The actions 128 are associated with sections of the first touch pad 108. The touch pad 108 is portioned using software or the like within the digital camera 100 that determines the location of a contact by a stylus, such as a human finger. In the embodiment of the camera shown in FIG. 2, the first touch pad 108 is divided into four sections, which are referred to as the first section 130, the second section 132, the third section 134, and the fourth section 136. The above-described sections of the first touch pad 108 correspond with the actions 128. Therefore, in order to initiate or activate an action, the corresponding section of the first touch pad 108 is contacted by a stylus. For example a user may rotate the displayed image by contacting the third section 134 of the first touch pad 108.

As described above, the touch pads 106 and/or the software associated with the touch pads 106 may be able to distinguish between a sliding motion and a pressing action on the touch pads 106. In the embodiment of the playback mode shown in FIG. 2, the actions may be selected by pressing the corresponding sections of the first touch pad 108. The actions may be changed as described above or by sliding the stylus on either of the touch pads 106.

The use of the touch pads 106 enables the digital camera 100 to provide several functions without an array of different buttons. In one embodiment, contact with one of the sections of the touch pad may cause more actions to be displayed. For example, a list of actions may be displayed wherein a user may scroll through the list of actions similar to the manner in which previously captured images may be viewed. Thus, more actions than the four displayed in FIG. 2 may be initiated. In addition, different action may be available in different modes, wherein the user may be able to scroll through the different actions and options.

In the embodiment of the digital camera 100 shown in FIG. 2, there are four LEDs 116, which are referred to individually as a first LED 140, a second LED 142, a third LED 144, and a third LED 146. Each of the LEDs 116 corresponds to an action displayed on the display 112 and a section of the first touch pad 108. In one embodiment, LEDs corresponding to actions that may be undertaken are illuminated. For example, if only three actions are possible, only three LEDs will illuminate. These illuminated LEDs are adjacent the sections of the first touch pad 108 that are contacted to initiate the actions. In another embodiment, the LEDs 116 default to not illuminated. When an action associated with an LED is initiated, the LED illuminates to indicate that the action has been initiated or activated.

In another embodiment, the LEDs 116 may be used to indicate the actions rather than or in addition to having the actions displayed on the display 112. For example, the LEDs 116 may be in the shape of an icon or the like and may illuminate when the corresponding option or action is available. Icons could be printed on the digital camera next to the LEDs 116 wherein the icons represent different actions or options available in different modes.

Having described the playback mode, the live view mode will now be described in greater detail. As described above, the live view mode of the digital camera 100 enables a user to view images on the display 112 as the images are being captured. A user may cause the digital camera 100 to enter live view mode by pressing one of the buttons 122 or by pressing a certain area on the touch pads 106.

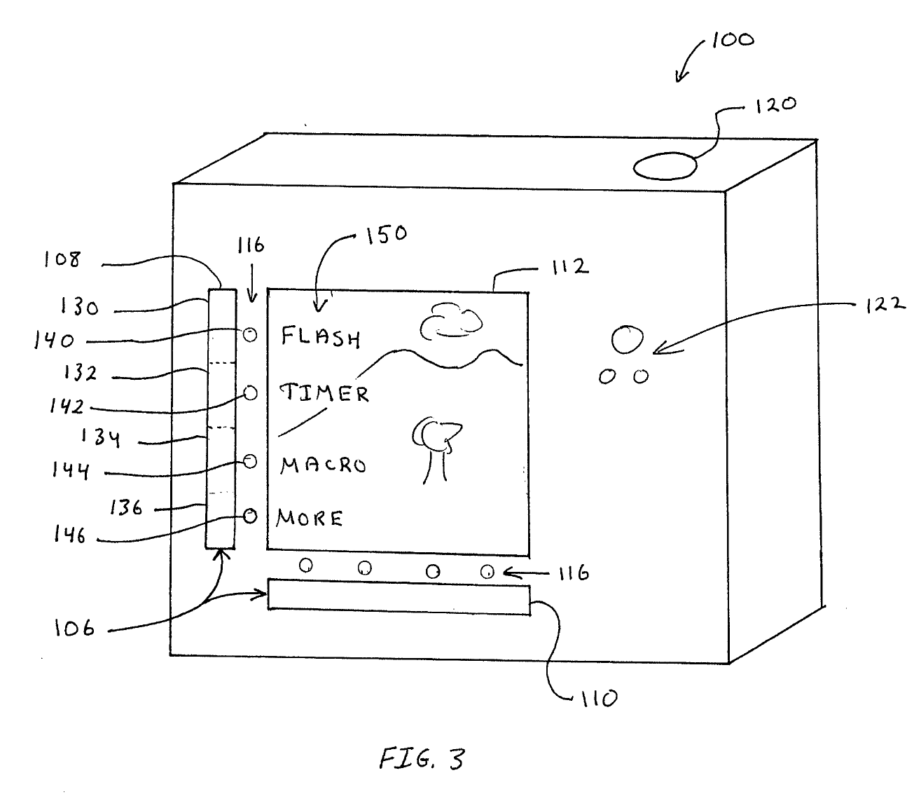

An embodiment of the digital camera 100 in the live view mode is shown in FIG. 3. Actions 150 associated with capturing images may be displayed on the display 112. The actions 150 are shown in FIG. 3 as being next to the first touch pad 108. However, the actions 150 may be located above the second touch pad 110. Actions include, but are not limited to, aperture size, exposure time, contrast, color balance, gain, exposure compensation, flash, zoom, and delayed capture. Delayed capture operates a timer wherein an image is captured after a preselected period of time.

A user may point the digital camera 100 at a scene that is to be captured and the scene may be displayed on the display 112. The user may then use the touch pads 106 to change capture or exposure settings in a manner similar to the way in which actions associated with the playback mode were activated. For example, the user may turn the flash on and off or set the flash to an automatic mode by pressing the first portion 130 of the first touch pad 108. Continually pressing the first portion 130 of the first touch pad 108 may cause the digital camera to cycle through the flash settings. In another embodiment, sliding or otherwise contacting the second touch pad 110 may change the setting. Thus, the digital camera 100 may be put in a mode to change the flash by contacting the first portion 130 of the first touch pad 108 and the flash setting may be changed by contacting the second touch pad 110. The same is applicable for other actions.

It is noted that the above described actions may be achieved using a single touch pad. When a section of a touch pad is pressed corresponding to a action, the touch pad may switch to a scrolling mode and allow the user to scroll through the flash options. The touch pad may then be tapped, which would cause the soft keys or actions to be displayed. The soft keys or actions may also be displayed after a preselected period of time.

When the user has established the appropriate settings, the image or scene may be captured by pressing the capture button 120. The captured image or scene may then be viewed using the playback mode as described above.

What is claimed is:

1. A digital camera comprising:
a display, wherein previously captured images are displayable on said display when said camera is in a first mode and wherein images of scenes that are capturable by said camera are displayable on said display when said camera is in a second mode; and
a touch pad located proximate said display;
wherein contact by a stylus on said touch pad causes said display to display different previously captured images when said camera is in said first mode; and
wherein at least one icon representative of at least one function is displayable on said display when said camera is in said second mode, and wherein contact by a stylus on said touch pad proximate said icon causes said at least one function to activate.

2. The digital camera of claim 1, wherein said stylus comprises a human body part.

3. The digital camera of claim 1, and further comprising at least one light proximate said touch pad.

4. The digital camera of claim 3, wherein said at least one light is located between said display and said touch pad.

5. The digital camera of claim 3, wherein said at least one light is located adjacent a portion of said touch pad that activates said at least one function.

6. The digital camera of claim 3, wherein said at least one light is illuminatable when said at least one icon is displayed.

7. The digital camera of claim 3, wherein said at least one light is illuminatable when said at least one function is activated.

8. The digital camera of clam 1, wherein said at least one exposure function comprises at least one member of the group consisting of aperture size, exposure time, contrast, color balance, gain, exposure compensation, flash, zoom, and delayed capture.

9. The digital camera of claim 1, wherein said contact by said stylus comprises sliding said stylus on said touch pad.

10. The digital camera of claim 1, wherein said contact by said stylus comprises tapping said stylus on said touch pad.

11. The digital camera of claim 1, wherein said camera is in said first mode if said stylus is slid on said touch pad and wherein said camera is in said second mode if said stylus is pressed on said touch pad.

12. The digital camera of claim 1, wherein said at least one icon is text.

13. The digital camera of claim 1, wherein at least one second icon representative of at least one second function is displayable on said display when said camera is in said second mode.

14. The digital camera of claim 13, wherein said at least one second icon is displayable proximate said touch pad.

15. The digital camera of claim 13, wherein said at least one second function is activated when said touch pad is contacted.

16. The digital camera of claim 1, and further comprising at least two touch pads.

17. A method of viewing images stored on a digital camera comprising:
causing said digital camera to enter a first mode wherein at least one previously captured image is displayed on a display portion of said digital camera; and
moving a stylus on a touch pad portion of said digital camera, wherein said moving causes at least one second previously captured image to be displayed on said display portion;
wherein images that may be captured by said digital camera are displayed on said display portion when said digital camera is in a second mode.

18. The method of claim 17, wherein said moving of said stylus on said touch pad causes one said at least one second image to be displayed.

19. The method of claim 17, wherein said moving of said stylus on said touch pad causes a plurality of images to be displayed sequentially on said touch pad during the period of said moving.

20. A method of operating a digital camera comprising:
displaying at least one first image on a display portion of said digital camera when said digital camera is in a first mode;
displaying at least one second image on said display portion when said camera is in said first mode and upon movement of a stylus on a touch pad portion of said digital camera; and
displaying a image that is able to be captured by said digital camera on said display portion when said digital camera is in a second mode.

21. The method of claim 20, and further comprising displaying at least one icon associated with at least one function on said display portion wherein contact by said stylus on said touch pad proximate said at least one icon activates said at least one function.

22. The method of claim 21, and further comprising illuminating an indicator proximate said at least one icon.
